(19) United States
(12) Patent Application Publication
(10) Pub. No.: US 2009/0163180 A1
(43) Pub. Date: Jun. 25, 2009

(54) Method and System for Communicating in a Network

(75) Inventors: Sunil Badiger, Bangalore (IN); Ankur Mehrotra, Bangalore (IN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/338,045

(22) Filed: Dec. 18, 2008

(30) Foreign Application Priority Data
Dec. 18, 2007 (IN) 2652/DEL/2007

(51) Int. Cl. H04M 1/00; H04W 64/00

(52) U.S. Cl. 455/412.2; 455/456.2

(57) ABSTRACT

A method (300) and a system for communicating in a network are disclosed. The method includes receiving (304) an alert message from a network device at a first mobile device. The alert message is to initiate communication between the first communication device and a second communication device. The method also includes determining (306) whether the second communication device is authorized to receive a location information of the first communication device based on a predefined condition. The method also includes appending (308) the location information of the first communication device to a response message based on the determination. The location information is obtained from a location broadcast message. The method also includes transmitting (310) the response message from the first communication device to the second communication device via the network device.

### FIELD OF THE INVENTION

The present invention relates in general to communication networks, and more specifically, to communicate location information of communication devices in a network.

### BACKGROUND OF THE INVENTION

With increased use of communication devices like mobile phones, it is beneficial to provide personalized services to users. One of these personalized services is location determination. Location determination can be used to find out the location of mobile phones in a wireless communication network. For some cases, users may require to know their exact location, when visiting new places. In other instances, relatives may require to know the whereabouts of their family members. Also, police may want to know the location of certain criminals by tracking their location information. In all these examples, determining location of a mobile phone is a key aspect.

Mobile phone networks, like GSM based networks, inherently use the location of mobile phones, to ensure that the cellular provider is able to route calls to the phones at all times. GSM networks are divided into cells. Further, a group of cells is considered a location area. When a mobile phone travels from a cell in one location area to a cell in another location area, the phone performs a location area update to inform the network about it's location. Further, a mobile phone can obtain it's location from a location message broadcast from a base station serving a particular cell. In this way, both the network and the mobile phone are made aware of the current location of the user bearing the phone.

Another way of determining the position is by using Global Positioning System (GPS). GPS provides accurate information about the position of a mobile phone. However, to enable GPS services, a mobile phone should have special hardware and software capabilities. Further, for some cases, users might not be interested in knowing their exact position and only a broad knowledge about the location, for example, name of the area, may be sufficient for them.

Further, these technologies for location determination require a lot of processing at the communication device side as well as the network side. Conventional location based services require devices, for example, satellite or any other central monitoring unit, in addition to the standard network devices for processing and transmitting the location information. Further, by using these technologies users may not be able to automatically share or exchange their location with their relatives.

### BRIEF DESCRIPTION OF DRAWINGS

The accompanying figures, where like reference numerals refer to identical or functionally similar elements throughout the separate views, and which, together with the detailed description below, are incorporated in and form part of the specification, serve to further illustrate various embodiments and to explain various principles and advantages, all in accordance with the present invention.

FIG. 1 illustrates an environment where various embodiments of the present invention can be practiced;

FIG. 2 illustrates a block diagram of an exemplary system for communicating, in accordance with an embodiment of the present invention;

FIG. 3 is a flow diagram illustrating a method for communicating location information in a network, in accordance with an embodiment of the present invention; and

FIG. 4 illustrates a set-up for communicating location information in a network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

For one embodiment, a method for communicating in a network is provided. The method includes receiving an alert message from a network device at a first mobile device. The alert message is to initiate communication between the first mobile device and a second mobile device. The method also includes determining whether the second mobile device is authorized to receive location information of the first mobile device based on a predefined condition. Further, the method includes appending the location information of the first mobile device to a response message based on the determination. The location information is obtained from a location broadcast message. Furthermore, the method includes transmitting the response message from the first mobile device to the second mobile device via the network device.

For another embodiment, a system for communicating in a network is provided. The system includes a receiver configured to receive an alert message from a network device at a first mobile device. The alert message is to initiate communication between the first mobile device and a second mobile device. The system also includes a comparator configured to determine whether the second mobile device is authorized to receive a location information of the first mobile device based on a predefined condition. Further, the system includes a controller configured to append the location information of the first mobile device to a response message based on the determination. The location information is obtained from a location broadcast message. Furthermore, the system includes a transmitter configured to transmit the response message from the first mobile device to the second mobile device via the network device.

Before describing in detail the particular method and system for communicating in a network in accordance with various embodiments of the present invention, it should be observed that the present invention utilizes a combination of method steps and apparatus components related to the method and system for communicating in a network. Accordingly, the apparatus components and method steps have been represented where appropriate by conventional symbols in the drawings, showing only those specific details that are pertinent for an understanding of the present invention so as not to obscure the disclosure with details that will be readily apparent to those with ordinary skill in the art having the benefit of the description herein.

In this document, relational terms such as first, second and the like may be used solely to distinguish one entity or action from another entity or action, without necessarily requiring or implying any actual relationship or order between such entities or actions. The terms ‘comprises,’ ‘comprising,’ ‘includes,’ ‘including,’ or any other variation thereof, are intended to cover a non-exclusive inclusion, such that a process, method, article, system or apparatus that comprises a list of elements does not include only those elements but may include other elements not expressly listed or inherent to such process, article, or apparatus. An element proceeded by ‘comprises . . . a’ does not, without more constraints, preclude the existence of additional identical elements in the process, method, article or apparatus that comprises the element. The terms ‘includes’ and/or ‘having’, as used herein, are defined as comprising.

The term ‘another,’ as used in this document, is defined as at least a second or more. The term ‘includes’ as used herein, are defined as comprising.

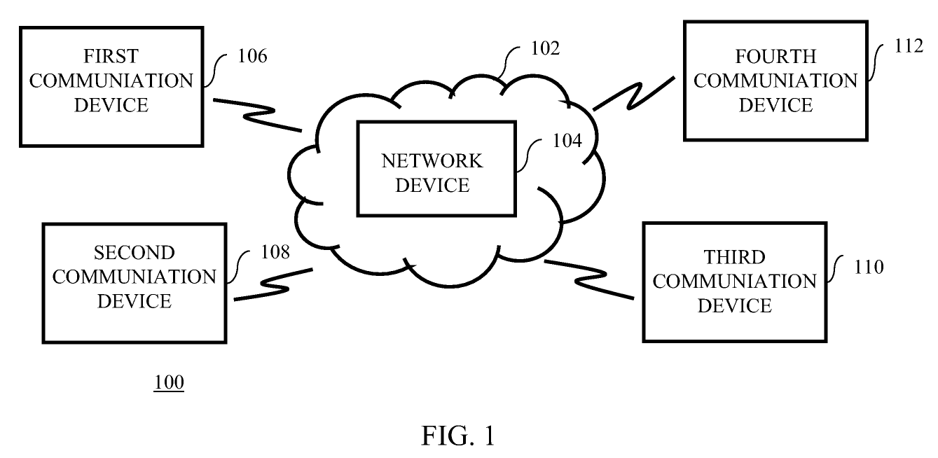

FIG. 1 illustrates an environment 100 where various embodiments of the present invention can be practiced. The environment 100 can include a network 102, a network device 104, first communication device 106, second communication device 108, third communication device 110 and fourth communication device 112. The network 102 includes the network device 104. Examples of the network 102 can include, but are not limited to, the Internet, a mobile communication network, Public Land Communication Network (PLMN) and Public Switched Telephone Network (PSTN). The network device 104 can facilitate wireless communication between various communication devices in the network 102. Examples of the network device 104 can include, but are not limited to, Base Transceiver Station (BTS), Base Station (BS) and Radio Base Station (RBS). Further, the first communication device 106, the second communication device 108, a third communication device 110 and the fourth communication device 112 can communicate in the network 102. Examples of the communication devices 106, 108, 110 and 112 can include, but are not limited to, communication phones, Personal Digital Assistants (PDAs) and smart phones. Although only the network device 104 and communication devices 106, 108, 110 and 112 have been shown in FIG. 1, it will be apparent to a person ordinarily skilled in the art that the environment 100 can include more or less number of network devices and communication devices.

For one embodiment, a communication device can communicate with one or more communication devices in the network 102. For example, the first communication device 106 in the environment 100 can communicate with, for example, the second communication device 108 over the network 102. Further, a user of the second communication device 108 can make a call, for example, a voice call, to a user of the first communication device 106. The user of the second communication device 108 after making the call to the first communication device 106 waits for a call set-up process. The call set-up process can include checking the first communication device 106 to receive the call. The call is established between the first communication device 106 and the second communication device 108 if the first communication device 106 is free to receive the call. After the call set-up is complete, the first communication device 106 starts ringing and at the same time the user of the second communication device 108 can simultaneously listen to a ringing tone. For the sake of clarity, the present invention has been explained in conjunction with the first communication device 106 as the called device, and the second communication device 108 as the caller device in the following description. However, it will be apparent to a person ordinarily skilled in the art that any of the communication devices in the network 102 can act as both a called device and a caller device under various circumstances.

Besides communicating in the communication network 102, the communication devices 106, 108, 110 and 112 can also obtain their location information from the network device 104. For one embodiment, location information of the network device 104 can be broadcasted to all the communication devices in the network 102 by the network device 104. This enables the communication devices in the network to obtain their location information. For example, a BTS near Forum Mall in Bangalore can broadcast the location information as ‘Forum Mall’. This broadcast message can be received by all the communication devices within the coverage area of the BTS. As a result, a communication device will display it's location as ‘Forum Mall’ to a user of the communication device. Consequently, a user can be made aware that he is near Forum Mall in Bangalore.

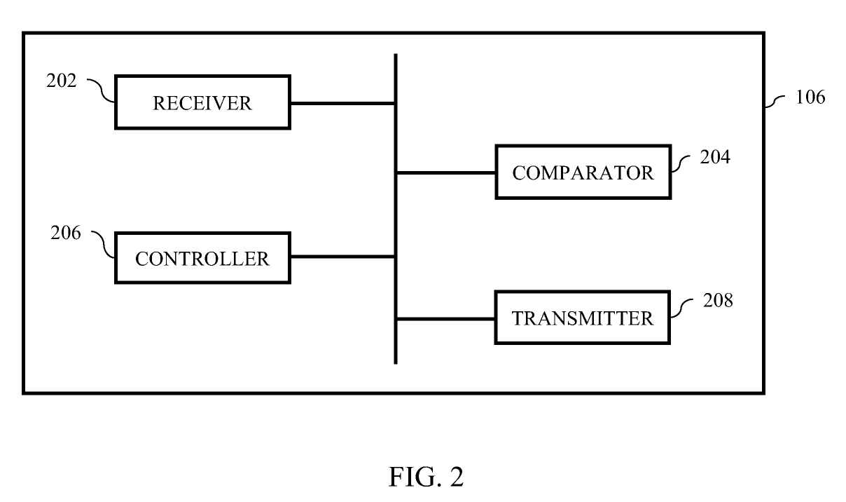

FIG. 2 illustrates a block diagram of the first communication device 106, in accordance with an embodiment of the present invention. For one embodiment, the communication device 106 can include a receiver 202, a comparator 204, a controller 206, and a transmitter 208.

The receiver 202 is configured to receive an incoming signal from the network device 104. For one embodiment, the incoming signal can include, for example, alert messages. For another embodiment, the incoming signal can include, for example, response messages and call confirmed messages and any other network broadcast or communication device messages.

The comparator 204 is configured to determine whether the location information of the first communication device 106 should be transmitted to the communication devices in the communication network based on a predefined condition. The predefined condition can include comparing an identifier associated with the communication devices to a list of identifiers maintained at the first communication device 106. Examples of the identifier, include, but are not limited to, a phone number of the communication device, a Personal Identification Number (PIN) and a Mobile Identification Number (MIN). The first communication device 106 can include a memory module configured to store the list of identifiers.

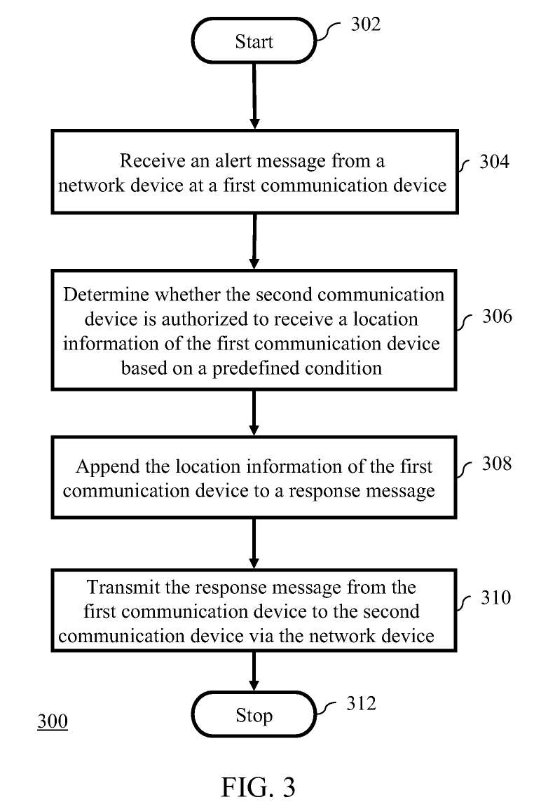

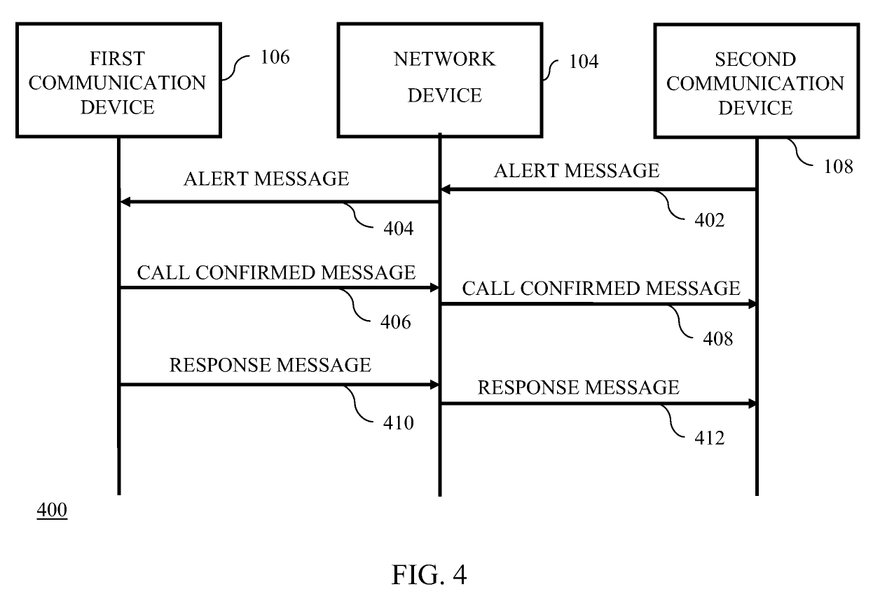

The controller 206 is configured to control the transmission of the location information of the first communication device 106 to the communication devices in the network 102. The controller 206 ascertains whether the location information should be transmitted based on the comparison carried out by the comparator 204. For one embodiment, the location information of the first communication device 106 can be, for example, appended to a response message. Appending of the location information to the response message will be described in detail in conjunction with FIGS. 3 and 4. For another embodiment, the location information of the first communication device 106 can be, for example, appended to the alert message. Appending of the location information to the response message will be described in detail in conjunction with FIGS. 3 and 4. The transmitter 208 is configured to transmit an outgoing signal from the first communication device 106. The outgoing signal is transmitted from the first communication device 106 to the communication devices in the network 102 via a network device 104. For one embodiment, the outgoing signal can include, for example, response messages and call confirmed messages and any other communication device messages. For another embodiment, the outgoing signal can be, for example, alert messages.

FIG. 3 is a flow diagram illustrating a method 300 for communicating location information in the network 102, in accordance with an embodiment of the present invention. At step 302, the method 300 can be initiated. A user of the second communication device 108 can make a call to a user of the first communication device 106. During the call set-up stage, the second communication device 108 can send an alert message to the first communication device. For one embodiment, the alert message may notify the first communication device 106 that the second communication device 108 intends to set-up the call. Further, the second communication device 108 can send the alert message via the network device 104. At step 304, the receiver 202 of the first communication device 106, receives the alert message from the network device 104. After the alert message is received at the first communication device 106, at step 306, the comparator 204 determines whether the second communication device 108 is authorized to receive a location information of the first communication device 106. The comparator 204 can determine this based on a predefined condition. For one embodiment, the predefined condition can include comparing an identifier associated with a calling party i.e. the second communication device 108 with a list of identifiers. For one embodiment, the list of identifiers can be maintained at the called party i.e. the first communication device 106. Further, a user of the first communication device 106 can configure the list of identifiers at his discretion. Further, a user can customize the list of identifiers by, for example, adding, deleting, changing and modifying, any identifier present in the list of identifiers. The identifiers taken to populate the list of identifiers may or may not be selected from a pre-existing phonebook at the first communication device 106. For one embodiment, the user of the communication devices can activate or de-activate a show location information service. Depending on the status of the show location service, the communication devices can exchange location information in the network 102. The communication devices will transmit its location information to other communication devices in the network 102 when the show location service is activated on these devices. For example, the first communication device 106 transmits its location information when its user has activated the show location service.

For one embodiment, all the communication devices within the coverage area of the network device 104 can receive a location information from the network device in form of a location broadcast message. The network device 104 broadcasts the location broadcast message to the communication devices over a Cell Broad-Casting Channel (CBCH) by using a Short Message Service Cell Broadcast (SMSCB) service. This location broadcast message contains the location information of the network device 104, within which all the communication devices are operating. In accordance with the SMSCB technology, a text or binary message can be defined and distributed to the communication devices within the network coverage area of the network device 104 in the network.

When it is determined at step 306 that the second communication device 108 is authorized to receive the location information of the first communication device 106, then at step 308, the controller 206 appends the location information of the first communication device 106 to a response message. The response message can include an Information Element (IE) part. The IE can be used for storing and conveying information between the communication devices and the network device 104 within a network. The information stored in the IE can include, but are not limited to, an identifier of a communication, location information of a communication device, a length of the content and a protocol discriminator. For one embodiment, the location information can be inserted in the IE part of the response message. At step 310, the transmitter 208 transmits the response message 410 to the second communication device 108 via the network device 104. For one embodiment, the response message can notify the second communication device 108 that the call has been successfully set-up with the first communication device 106. The method 300 ends at step 312.

FIG. 4 illustrates a set-up 400 for communicating location information in a network, in accordance with an embodiment of the present invention. The set-up 400 can include the network device 104, the first communication device 106, and the second communication device 108. For the sake of clarity, the set-up has been described in accordance with communication between two communication devices by using a network device 104. However, it will be apparent to a person ordinarily skilled in the art that the set-up 400 can include more than two communication devices and more than one network device 104.

For one embodiment, a user of the second communication device 108 can make a call to the first communication device 106. Typically, the user can set up a call with the first communication device 106 by using various methods known in the art, for example, the user may dial in a number associated with the first communication device 106. For one embodiment, after the user initiates the process of making a call, the second communication device 108 can send a call request, for example, an alert message 402 to the network device 104 to request for setting up a call with the first communication device 106. The alert message 402 can include data related to the calling party, i.e. the second communication device 108, data related to the called party, i.e. the first communication device 106, data related to communication protocol followed etc. On receiving the alert message 402, the network device 104 identifies the called party from the data contained in the alert message 402. Based on the identification of the called party, the network device 104 can track the location of the first communication device 106. For this, the network device 104 may be required to contact other network devices in the network 102. After identifying the location of the called party, the network device 104 can send an alert message 404 to the first communication device 106.

On receiving the alert message 404, the first communication device 106 decodes the alert message 404 to identify the calling party. Further, the first communication device 106 starts ringing to notify a user of the first communication device 106 about an incoming call from the second communication device 108. In order to send an acknowledgement to the network device 104 for successful reception of the alert message 404, the first communication device 106 can send a call confirmed message 406 to the network device 104. For one embodiment, the call confirmed message 406 can be used to notify the network device 104 that the first communication device 106 is ready for a call with the second communication device 108. On receiving the call confirmed message 406, the network device 104 notifies the second communication device 108 that the first communication 106 is ready for the call. For this, the network device 104 can transmit a call confirmed message 408 to the second communication device 108.

In addition to sending the call confirmed message 406, the first communication device 106 transmits a response message 410 to the network device 104. For one embodiment, the response message 410 can be transmitted in response to the alert message 402. Before transmitting the response message 410, the first communication device 106 checks whether the second communication device 108 is authorized to view location of the first communication device 106. In case the second communication device 108 is authorized to view the location information, the response message 410 can include location information of the first communication device 106 appended to an Information Element (IE) part of the response message 410.

The first communication device 106 can obtain its location information and append it to the response message 410 in accordance with the methodology described in conjunction with FIG. 3. On receiving the response message 410 from the first communication device 106, the network device 104 can forward it to the second communication device 108 as response message 412. On receiving the response message 412, the second communication device 108 decodes the response message to obtain the location information of the first communication device 106. Further, the second communication device 108 can be configured to display this location information at a display device.

For one embodiment, the alert message 402 transmitted from the second communication device 108 can include location information of the second communication device 108. The second communication device 108 can obtained its location information and append it to the alert message 402 in accordance with the methodology described in conjunction with FIG. 3. Further, the network device 104 can forward the alert message 402 as the alert message 404. On receiving the alert message 404, the first communication device 106 can decode the alert message and extract the location information of the second communication device 108. Further, the first communication device 106 can be configured to display this location information at the display device. The location information is displayed at the first communication device 106 based on the extraction.

Various embodiments of the present invention offer one or more advantages. The present invention provides a method and system for communicating location information in a network. The present invention ensures that a location information can be exchanged automatically between the communication devices i.e. a caller device and a called device, without using any additional infrastructure. Consequently, the present invention ensures that a caller device can receive a location information of a called device without any user intervention. The present invention also ensures that the user of the called device has an option to authorize the caller device to receive its location information. Further, the present invention ensures that the called device can also receive the location information of the caller device. Moreover, the present invention does not require any changes to communication protocols currently being used.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method for communicating call intents. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for communicating in a network, the method comprising:
receiving an alert message from a network device at a first communication device, wherein the alert message is to initiate communication between the first communication device and a second communication device;
determining whether the second communication device is authorized to receive a location information of the first communication device based on a predefined condition;
appending the location information of the first communication device to a response message based on the determination, wherein the location information is obtained from a location broadcast message; and
transmitting the response message from the first communication device to the second communication device via the network device.

2. The method as recited in claim 1, wherein the predefined condition comprises comparing an identifier associated with the second communication device with a list of identifiers maintained at the first communication device.

3. The method as recited in claim 2 further comprising configuring the list of identifiers at the first communication device, wherein the list of identifiers is configured by a user of the first communication device.

4. The method as recited in claim 1, wherein appending the location information of the first communication device to the response message comprises inserting the location information to an information element of the response message.

5. The method as recited in claim 1 further comprising broadcasting the location broadcast message over a Cell Broad-Casting Channel (CBCH) by using a Short Message Service Cell Broadcast (SMSCB) service, wherein the location broadcast message is broadcasted from the network device.

6. The method as recited in claim 1 further comprising decoding the response message at the second communication device.

7. The method as recited in claim 6 further comprising displaying the location information of the first communication device at the second communication device based on the decoding.

8. The method as recited in claim 1 further comprising receiving a call request for the first communication device from the second communication device at the network device.

9. The method as recited in claim 1 further comprising responding to the alert message by using a call confirmed message, wherein the call confirmed message is transmitted when the first communication device is ready to accept the call.

10. The method as recited in claim 1 further comprising activating a show location information service at the first communication device, wherein the show location information service is activated by a user of the first communication device.

11. The method as recited in claim 1, wherein the alert message includes location information of the second communication device.

12. The method as recited in claim 11 further comprising extracting the location information of the second communication device from the alert message at the first communication device.

13. The method as recited in claim 12 further comprising displaying the location information of the second communication device at the first communication device based on the extraction.

14. A system for communicating, the system comprising:
a receiver configured to receive an alert message from a network device at a first communication device, wherein the alert message is to initiate communication between the first communication device and a second communication device;
a comparator configured to determine whether the second communication device is authorized to receive a location information of the first communication device based on a predefined condition;
a controller configured to append the location information of the first communication device to a response message based on the determination, wherein the location information is obtained from a location broadcast message; and
a transmitter configured to transmit the response message from the first communication device to the second communication device via the network device.

15. The system as recited in claim 14, wherein the predefined condition comprises comparing an identifier associated with the second communication device with a list of identifiers maintained at the first communication device.

16. The system as recited in claim 15 further comprising a memory module, wherein the memory module is configured to store the list of identifiers.

17. The system as recited in claim 14, wherein the response message comprises an information element.

18. The system as recited in claim 14, wherein the location information of the first communication device is obtained from a location broadcast message, wherein the location broadcast message is broadcasted from the network device.

19. The system as recited in claim 18, wherein the location broadcast message is transmitted over a Cell Broad-Casting Channel (CBCH) by using a Short Message Service Cell Broadcast (SMSCB) service.
